(19) United States
(12) Patent Application Publication
(10) Pub. No.: US 2014/0304384 A1
(43) Pub. Date: Oct. 9, 2014

(54) UPLOADING LARGE CONTENT ITEMS

(71) Applicant: Dropbox, Inc., San Francisco, CA (US)

(72) Inventors: Chris Varenhorst, San Francisco, CA (US); Kyle Consalus, San Francisco, CA (US)

(73) Assignee: Dropbox, Inc., San Francisco, CA (US)

(21) Appl. No.: 13/856,876

(22) Filed: Apr. 4, 2013

(51) Int. Cl. H04L 12/24

(52) U.S. Cl. CPC H04L 41/50
USPC 709/223

(57) ABSTRACT

Disclosed are systems, methods, and non-transitory computer-readable storage media for uploading a content item to a content management system in fixed size data blocks. A client device can split a content item into fixed size data blocks and create a unique identifier for each of the fixed size data blocks. The unique identifiers can be and transmitted to the content management system to determine which fixed size data blocks are already stored on the content management system. The client device can create a unique identifier for a fixed size data block by using at least a portion of the fixed size data block as input in a hashing algorithm. The resulting hash output can be the unique identifier. The content management system can search for the unique identifiers in a content item index that lists the unique identifier for each fixed size data block stored on the content management system.

### TECHNICAL FIELD

The present technology pertains to uploading content items, and more specifically pertains to uploading a content item as fixed size data blocks.

### BACKGROUND

Cloud storage accounts allow users to store their content items in an online storage account that can be accessed from any computing device with a network connection. Users can thus upload content items such as pictures, songs, documents, etc. from a computing device to their online storage account and later access the content items from different computing devices. Once uploaded, content items can be conveniently accessed, however uploading the content items can be problematic. This is especially true when a content item is a large content item such as a video. Due to their large size, large content items can take a long time to be uploaded. This can require a user to maintain network connection for an extended period of time while the entire content item is uploaded. This can be particularly problematic when a user is attempting to upload the content item from a mobile computing device such as a smart phone because data usage via the mobile computing device's cellular network connection may be associated with a high cost. Thus, to avoid data charges, the user may have to remain in a location where a Wi-Fi network connection is available until the content item is completely uploaded. Further, the process of uploading the entire content item has to be repeated each time a small change is made to the content item. Accordingly, there is a need for an improved method of uploading content items.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for uploading a content item to a content management system from a client device. The client device can be configured to upload a content item to the content management system in fixed size data blocks rather than as one data file. To accomplish this, the client device can split the content item into fixed size data blocks. Further, the client device can communicate with the content management system to determine which of the fixed size data blocks are stored on the content management system. Thus the client device can upload only those fixed size data blocks not already stored on the content management system.

To accomplish this, the client device can be configured to create a unique identifier for each of the fixed size data blocks and transmit the unique identifiers to the content management system. The client device can create a block identifier for a fixed size data block by using at least a portion of the fixed size data block as input in a hashing algorithm. The resulting hash output can be the block identifier.

The content management system can use the block identifiers received from the client device to identify the fixed size data blocks that are not stored on the content management system and thus need to be uploaded by the client device. For example, the content management system can search for the block identifiers on a content item index that lists the block identifier for each fixed size data block stored on the content management system.

The content management system can transmit a response message to the client device identifying the fixed size data blocks that are not stored on the content management system and thus need to be uploaded. In response, the client device can upload the identified fixed size data blocks to the content management system.

In some embodiments, the content management system can verify each uploaded fixed size data block to ensure that the fixed size data block on the content management system matches the fixed size data block on the client device. For example, the content management system can create a unique identifier for the uploaded fixed size data block using the same method used by the client device to create a block identifier for a fixed size data block. The content management system can compare the block identifier created by the content management system with the block identifier created by the client device to determine if the fixed size data block uploaded to the content management system is the same as the fixed size data block on the client device.

Further, the content management system can verify each uploaded content item upon each of the fixed size data blocks of the content item being stored on the content management system. In some embodiments, the content management system can compare the data size of the content item on the content management system with a data size of the content item received from the client device.

Further, the content management system can verify that the content item uploaded to the content management system matches the content item on the client device by creating a unique content item identifier for the content item using the same method the client device uses to create a unique content item identifier. The content management system can compare the unique content item identifier created by the content management system with the unique content item identifier received from the client device to verify that the content item on the content management system matches the content item on the client device.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 shows an exemplary configuration of devices and a network in accordance with the invention;

FIG. 2 shows an exemplary embodiment of a client device configured to upload content items to a content management system;

FIG. 3 shows splitting a content item into fixed size data blocks and creating unique identifiers for each of the fixed size data blocks;

FIG. 4 shows an exemplary embodiment of a content item index used to determine if a fixed size data block is stored on a content management system;

FIG. 5 shows an exemplary method embodiment of a client device uploading a content item to a content management system;

FIG. 6 shows an exemplary method embodiment of a content management system receiving an uploaded content item from a client device; and

FIGS. 7A and 7B show exemplary possible system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for uploading content items to a content management system. Uploading an entire content item to a content management system as one large data file can be difficult because interruption of the upload can result in the upload having to be restarted. Thus any portion of the content item uploaded to the content management system prior to the interruption must be re-uploaded when the upload process is restarted.

The disclosed technology uploads a content item in multiple fixed size data blocks, rather than uploading the entire content item as one large data file. The fixed size data blocks can be uploaded to the content management system one at a time. Thus, interruption of an upload results in a re-upload of at most, only one of the fixed size data blocks, rather than the entire portion of the content item that was uploaded prior to the interruption. Any of the fixed size data blocks that completed uploading prior to the interruption do not need to be re-uploaded to the content management system.

A further advantage of uploading content items as fixed size data blocks is that the fixed size data blocks stored on the content management system can be used for multiple content items. For example, rather than re-upload an entire content item when the content item has been modified, only the fixed size data blocks that have been changed as a result of the modification to the content item need to be uploaded to the content management system. Any of the fixed size data blocks that remained unchanged by the modification to the content item can be used for the revised content item. Thus content items can be uploaded faster and without fear of interruption.

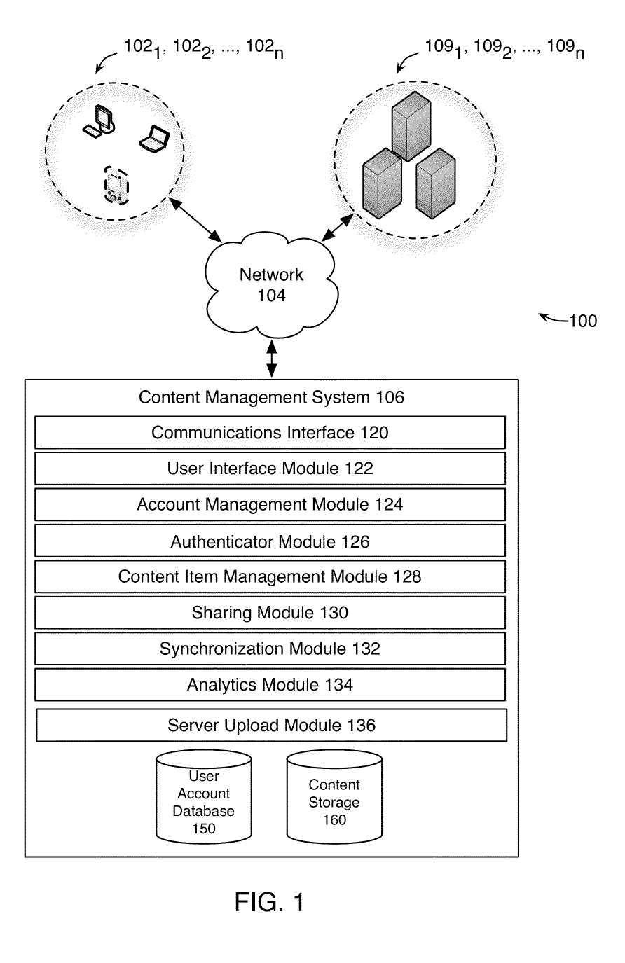

An exemplary system configuration 100 is illustrated in FIG. 1, wherein electronic devices communicate via a network for purposes of exchanging content and other data. The system can be configured for use on a wide area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, a user can interact with content management system 106 through client devices 102₁, 102₂, . . . , 102ₙ (collectively “102”) connected to network 104 by direct and/or indirect communication. Content management system 106 can support connections from a variety of different client devices, such as desktop computers; mobile computers; mobile communications devices, e.g. mobile phones, smart phones, tablets; smart televisions; set-top boxes; and/or any other network enabled computing devices. Client devices 102 can be of varying type, capabilities, operating systems, etc. Furthermore, content management system 106 can concurrently accept connections from and interact with multiple client devices 102.

A user can interact with content management system 106 via a client-side application installed on client device 102ᵢ. In some embodiments, the client-side application can include a content management system specific component. For example, the component can be a stand-alone application, one or more application plug-ins, and/or a browser extension. However, the user can also interact with content management system 106 via a third-party application, such as a web browser, that resides on client device 102ᵢ and is configured to communicate with content management system 106. In either case, the client-side application can present a user interface (UI) for the user to interact with content management system 106. For example, the user can interact with the content management system 106 via a client-side application integrated with the file system or via a webpage displayed using a web browser application.

Content management system 106 can make it possible for a user to store content, as well as perform a variety of content management tasks, such as retrieve, modify, browse, and/or share the content. Furthermore, content management system 106 can make it possible for a user to access the content from multiple client devices 102. For example, client device 102ᵢ can upload content to content management system 106 via network 104. The content can later be retrieved from content management system 106 using the same client device 102ᵢ or some other client device 102.

To facilitate the various content management services, a user can create an account with content management system 106. The account information can be maintained in user account database 150. User account database 150 can store profile information for registered users. In some cases, the only personal information in the user profile can be a username and/or email address. However, content management system 106 can also be configured to accept additional user information.

User account database 150 can also include account management information, such as account type, e.g. free or paid; usage information, e.g. file edit history; maximum storage space authorized; storage space used; content storage locations; security settings; personal configuration settings; content sharing data; etc. Account management module 124 can be configured to update and/or obtain user account details in user account database 150. The account management module 124 can be configured to interact with any number of other modules in content management system 106.

An account can be used to store content, such as documents, text files, audio files, video files, etc., from one or more client devices 102 authorized on the account. The content can also include folders of various types with different behaviors, or other mechanisms of grouping content items together. For example, an account can include a public folder that is accessible to any user. The public folder can be assigned a web-accessible address. A link to the web-accessible address can be used to access the contents of the public folder. In another example, an account can include a photos folder that is intended for photos and that provides specific attributes and actions tailored for photos; an audio folder that provides the ability to play back audio files and perform other audio related actions; or other special purpose folders. An account can also include shared folders or group folders that are linked with and available to multiple user accounts. The permissions for multiple users may be different for a shared folder.

The content can be stored in content storage 160. Content storage 160 can be a storage device, multiple storage devices, or a server. Alternatively, content storage 160 can be a cloud storage provider or network storage accessible via one or more communications networks. Content management system 106 can hide the complexity and details from client devices 102 so that client devices 102 do not need to know exactly where the content items are being stored by content management system 106. In one variation, content management system 106 can store the content items in the same folder hierarchy as they appear on client device 102ᵢ. However, content management system 106 can store the content items in its own order, arrangement, or hierarchy. Content management system 106 can store the content items in a network accessible storage (SAN) device, in a redundant array of inexpensive disks (RAID), etc. Content storage 160 can store content items using one or more partition types, such as FAT, FAT32, NTFS, EXT2, EXT3, EXT4, ReiserFS, BTRFS, and so forth.

Content storage 160 can also store metadata describing content items, content item types, and the relationship of content items to various accounts, folders, or groups. The metadata for a content item can be stored as part of the content item or can be stored separately. In one variation, each content item stored in content storage 160 can be assigned a system-wide unique identifier.

Content storage 160 can decrease the amount of storage space required by identifying duplicate files or duplicate segments of files. Instead of storing multiple copies, content storage 160 can store a single copy and then use a pointer or other mechanism to link the duplicates to the single copy. Similarly, content storage 160 can store files more efficiently, as well as provide the ability to undo operations, by using a file version control that tracks changes to files, different versions of files (including diverging version trees), and a change history. The change history can include a set of changes that, when applied to the original file version, produce the changed file version.

Content management system 106 can be configured to support automatic synchronization of content from one or more client devices 102. The synchronization can be platform agnostic. That is, the content can be synchronized across multiple client devices 102 of varying type, capabilities, operating systems, etc. For example, client device 102ᵢ can include client software, which synchronizes, via a synchronization module 132 at content management system 106, content in client device 102ᵢ's file system with the content in an associated user account. In some cases, the client software can synchronize any changes to content in a designated folder and its sub-folders, such as new, deleted, modified, copied, or moved files or folders. The client software can be a separate software application, can integrate with an existing content management application in the operating system, or some combination thereof. In one example of client software that integrates with an existing content management application, a user can manipulate content directly in a local folder, while a background process monitors the local folder for changes and synchronizes those changes to content management system 106. Conversely, the background process can identify content that has been updated at content management system 106 and synchronize those changes to the local folder. The client software can provide notifications of synchronization operations, and can provide indications of content statuses directly within the content management application. Sometimes client device 102ᵢ may not have a network connection available. In this scenario, the client software can monitor the linked folder for file changes and queue those changes for later synchronization to content management system 106 when a network connection is available. Similarly, a user can manually stop or pause synchronization with content management system 106.

A user can also view or manipulate content via a web interface generated and served by user interface module 122. For example, the user can navigate in a web browser to a web address provided by content management system 106. Changes or updates to content in the content storage 160 made through the web interface, such as uploading a new version of a file, can be propagated back to other client devices 102 associated with the user's account. For example, multiple client devices 102, each with their own client software, can be associated with a single account and files in the account can be synchronized between each of the multiple client devices 102.

Content management system 106 can include a communications interface 120 for interfacing with various client devices 102, and can interact with other content and/or service providers 109₁, 109₂, . . . , 109ₙ (collectively “109”) via an Application Programming Interface (API). Certain software applications can access content storage 160 via an API on behalf of a user. For example, a software package, such as an app on a smartphone or tablet computing device, can programmatically make calls directly to content management system 106, when a user provides credentials, to read, write, create, delete, share, or otherwise manipulate content. Similarly, the API can allow users to access all or part of content storage 160 through a web site.

Content management system 106 can also include authenticator module 126, which can verify user credentials, security tokens, API calls, specific client devices, and so forth, to ensure only authorized clients and users can access files. Further, content management system 106 can include analytics module 134 module that can track and report on aggregate file operations, user actions, network usage, total storage space used, as well as other technology, usage, or business metrics. A privacy and/or security policy can prevent unauthorized access to user data stored with content management system 106.

Content management system 106 can include sharing module 130 for managing sharing content publicly or privately. Sharing content publicly can include making the content item accessible from any computing device in network communication with content management system 106. Sharing content privately can include linking a content item in content storage 160 with two or more user accounts so that each user account has access to the content item. The sharing can be performed in a platform agnostic manner. That is, the content can be shared across multiple client devices 102 of varying type, capabilities, operating systems, etc. The content can also be shared across varying types of user accounts.

In some embodiments, content management system 106 can be configured to maintain a content directory identifying the location of each content item in content storage 160. The content directory can include a unique content entry for each content item stored in the content storage.

A content entry can include a content path that can be used to identify the location of the content item in a content management system. For example, the content path can include the name of the content item and a folder hierarchy associated with the content item. For example, the content path can include a folder or path of folders in which the content item is placed as well as the name of the content item. Content management system 106 can use the content path to present the content items in the appropriate folder hierarchy.

A content entry can also include a content pointer that identifies the location of the content item in content storage 160. For example, the content pointer can include the exact storage address of the content item in memory. In some embodiments, the content pointer can point to multiple locations, each of which contains a portion of the content item.

In addition to a content path and content pointer, a content entry can also include a user account identifier that identifies the user account that has access to the content item. In some embodiments, multiple user account identifiers can be associated with a single content entry indicating that the content item has shared access by the multiple user accounts.

To share a content item privately, sharing module 130 can be configured to add a user account identifier to the content entry associated with the content item, thus granting the added user account access to the content item. Sharing module 130 can also be configured to remove user account identifiers from a content entry to restrict a user account's access to the content item.

To share content publicly, sharing module 130 can be configured to generate a custom network address, such as a uniform resource locator (URL), which allows any web browser to access the content in content management system 106 without any authentication. To accomplish this, sharing module 130 can be configured to include content identification data in the generated URL, which can later be used to properly identify and return the requested content item. For example, sharing module 130 can be configured to include the user account identifier and the content path in the generated URL. Upon selection of the URL, the content identification data included in the URL can be transmitted to content management system 106 which can use the received content identification data to identify the appropriate content entry and return the content item associated with the content entry.

In addition to generating the URL, sharing module 130 can also be configured to record that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing module 130 can be configured to change the value of the flag to 1 or true after generating a URL to the content item.

In some embodiments, sharing module 130 can also be configured to deactivate a generated URL. For example, each content entry can also include a URL active flag indicating whether the content should be returned in response to a request from the generated URL. For example, sharing module 130 can be configured to only return a content item requested by a generated link if the URL active flag is set to 1 or true. Thus, access to a content item for which a URL has been generated can be easily restricted by changing the value of the URL active flag. This allows a user to restrict access to the shared content item without having to move the content item or delete the generated URL. Likewise, sharing module 130 can reactivate the URL by again changing the value of the URL active flag to 1 or true. A user can thus easily restore access to the content item without the need to generate a new URL.

While content management system 106 and user devices 102 are presented with specific components, it should be understood by one skilled in the art, that the architectural configuration of content management system 106 and user devices 102 are simply one possible configuration and that other configurations with more or less components are also possible. For example, in some embodiments, client devices 102 and content management system 106 can be configured to manage uploading content items to content management system 106 in fixed size data blocks of the content item, rather than the entire content item as one large data block.

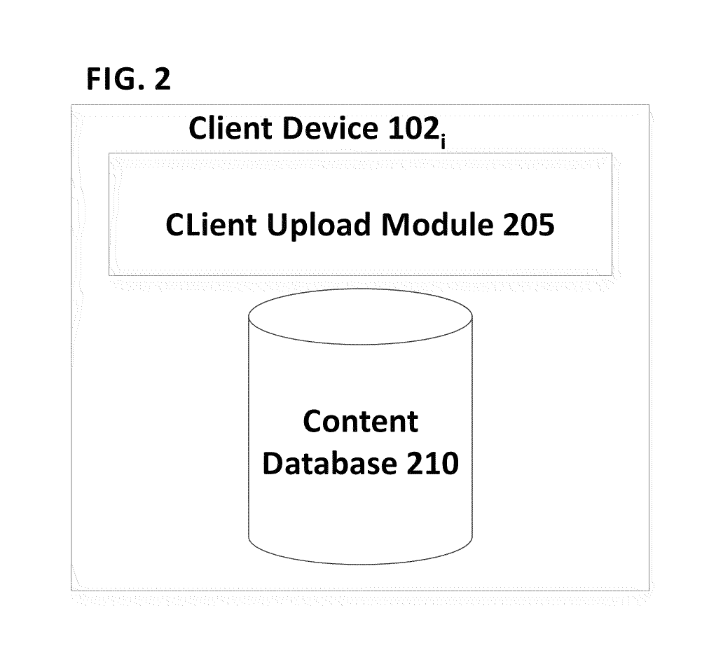

FIG. 2, which is described in view of FIG. 1, shows one exemplary embodiment of client device 102ᵢ including client upload module 205 configured to manage uploading content items to content management system 106. In some embodiments, client upload module 205 can be configured to upload a content item to content management system 106 upon receiving an upload command. An upload command can be a command that identifies a content item to be uploaded to content management system 106. In some embodiments, an upload command can be received by client upload module 205 as a result of a user selecting a content item to be uploaded to content management system 106. In some embodiments, an upload command can be received by upload module 205 as a result of a content item being identified for upload by an automatic upload process running on client device 102ᵢ.

Upon receiving an upload command, client upload module 205 can be configured to split the content item into fixed size data blocks to be uploaded to content management system 106. A fixed size data block can be a data block of any predetermined size such as 2 MB, 4 MB, etc., according to the preferences of the implementer. The resulting fixed size data blocks do not necessarily need to all be the same size, but rather limited to a maximum size. For example, a 10 MB content item can be split into three fixed size data blocks such that two of the fixed size data blocks are 4 MB and one is 2 MB. In some embodiments, client upload module 205 can split the content items consistently such that when two equal content items are split they will result in equal fixed size data blocks. Further, splitting the content item into fixed size data blocks can be advantageous in embodiments where content management system 106 also stores content items in similar fixed size data blocks.

In some embodiments, splitting the content item into fixed size blocks can include creating multiple files, each being a split sized data block. In some embodiments, however, splitting the content item into fixed size blocks can include identifying the multiple fixed size data blocks of the content item. For example, in some embodiments, client upload module 205 can scan the content item and identify the fixed size data blocks as the content item is scanned. Thus, the content item itself is not physically split into multiple files.

In some embodiments, client upload module 205 can be configured to upload the content item to content management system 106 as fixed size data blocks. For example, the client upload module 205 can upload the fixed size data blocks one at a time until each fixed size block is uploaded to content management system 106.

Uploading the content item as fixed size data blocks can minimize the amount of data that needs to be re-uploaded to content management system 106 if the upload of the content item is interrupted prior to completion. Interruption can result from numerous factors such as loss of network connection, loss of power, etc. When a data upload is interrupted, the data that was in the process of being uploaded but was not completely uploaded, must be re-uploaded to content management system 106. Thus, any portion of data that had been uploaded prior to interruption of the data upload, would have to be re-uploaded upon the data upload being interrupted. For example, if upload of a content item that is 100 MB is interrupted after 90 MB has already been uploaded; the entire content item has to be re-uploaded. Thus, the 90 MB that was previously uploaded has to be re-uploaded as well as the remaining 10 MB that was not uploaded.

By uploading a content item in multiple fixed size data blocks, the amount of data that would have to be re-uploaded as a result of an interruption is limited to the size of the fixed size data block. For example, if a 100 MB content item is uploaded as fixed size data blocks of 4 MB, interruption of the data upload can result in no more than 4 MB having to be re-uploaded. In some embodiments, client upload module 205 can be configured to track the progress of the fixed size data blocks that have been successfully uploaded to content management system 106. Thus, when an upload is interrupted, client upload module 205 can identify the fixed size blocks that were not uploaded to content management system 106 prior to the interruption.

In some embodiments, client upload module 205 can be configured to communicate with content management system 106 to determine which of the fixed size data blocks of a content item are stored on content management system 106 prior to uploading a content item. Client upload module 205 can thus avoid transmitting any fixed size data blocks of the content item that are already stored on content management system 106. For example, some of the fixed size data blocks of the content item may have been uploaded prior to upload of the content item being interrupted. Alternatively, the content item may be a modification of a previous version of the content item that has already been uploaded to content management system 106 and some of the fixed size data blocks of the content item may have not been affected by the modification. Thus, any fixed size data blocks of the content item that remained unchanged do not need to be re-uploaded to content management system 106. Alternatively, one of the fixed size data blocks may have been uploaded to content management system 106 from a different client device 102ⱼ that may or may not be associated with an account authorized on client device 102ᵢ.

To identify the fixed size data blocks of a content item that are stored on content management system 106, client upload module 205 can be configured to create a unique identifier for each unique fixed size data block of the content item and transmit the unique identifiers to content management system 106. Content management system 106 can include server upload module 136 configured to receive the unique identifiers and determine which of the fixed size data blocks identified by the unique identifiers are already stored on content management system 106. Server upload module 136 can transmit a message to client device 102; identifying any fixed size data blocks of the content item that are not stored on content management system 106 and thus need to be uploaded by client device 102ᵢ.

Client upload module 205 can be configured to create a unique identifier for a fixed size data block of a content item in any of numerous ways known in the art. In some embodiments, the unique identifier can be created using the fixed size data block. For example, the unique identifier can be the hash output resulting from using at least a portion of the fixed size data block as input in a hashing algorithm. The hashing algorithm used to create the unique identifier can be any of a variety of known hashing algorithms. For example, in some embodiments the hashing algorithm can be SHA256.

In some embodiments, the hashing algorithm can result in a unique hash output for each unique input entered into the hashing algorithm. Further, in some embodiments, the hashing algorithm can be deterministic such that if the hashing algorithm is called twice on “equal” input, the same hash output will be returned for each. Thus, for example, entering the same hash input, i.e. input consisting of the same sequence of characters, in the hashing algorithm will result in equal hash outputs.

Server upload module 136 can be configured to use a unique identifier received from client device 102; to determine whether the fixed size data block identified by the unique identifier is stored on content management system 106. In some embodiments, server upload module 136 can search for the unique identifier in a content item index that lists the unique identifiers for fixed size data blocks stored on content management system 106. For example, the content item index can be stored on content storage 160 and server upload module 136 can be configured to access and search the content item index for a unique server identifier received from client device 102ᵢ. If the unique identifier is found in the content item index, server upload module 136 can determine that the fixed size data block identified by the unique identifier is stored on content management system 106. Alternatively, if the unique identifier is not found in the content item index, server upload module 136 can determine that the fixed size data block identified by the unique identifier is not stored on content management system 106.

Server upload module 136 can be configured to transmit a message to client device 102ᵢ that identifies the fixed size data blocks of the content item that are not stored on content management system 106 and thus need to be uploaded to content management system 106. For example, in some embodiments, the message can include the unique identifier for each fixed size data block of the content item that was identified as not being stored on content management system 106. Alternatively, in some embodiments, the message can include the unique identifier of each fixed size data block that was identified as being stored on the content management system 106. Client upload module 205 can use the unique identifiers included in the message to identify the fixed size data blocks of the content items that need to be uploaded to content management system 106.

Client upload module 205 can be configured to upload any fixed size data blocks of the content item that have been identified by content management system 106 as not being stored on content management system 106. In some embodiments, content management system 106 can upload the identified fixed size data blocks one at a time such that as one fixed size data block completes uploading, client upload module 205 begins uploading another fixed size data block. Uploading the fixed size data blocks one at a time can minimize the amount of data that would have to be re-uploaded as a result of an interruption to the upload.

In some embodiments, client upload module 205 can upload multiple fixed size data blocks at one time. For example, client upload module can upload 2 or 3 fixed size data blocks simultaneously. In some embodiments, client upload module 205 can vary the number of fixed size data blocks that are uploaded simultaneously based on various factors such as the client device's network connection or location, as well as the time, day, user settings, etc.

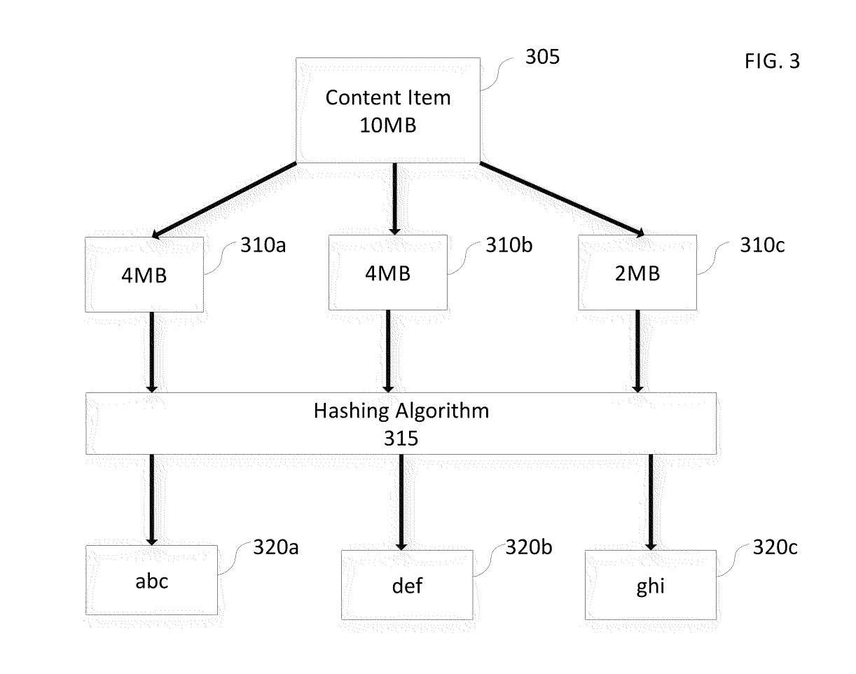

FIG. 3 shows splitting a content item into fixed size data blocks and creating unique identifiers for each of the fixed size data blocks. As shown, content item 305, which is 10 MB, is split into three fixed size data blocks 310a, 310b, 310c. Fixed size data block 310a and fixed size data block 310b are 4 MB and fixed size data block 310c is 2 MB.

To create unique identifiers, each fixed size data block is used as input to hashing algorithm 315. For example, fixed size data block 310a is used as input to hashing algorithm 315, which results in unique identifier 320a. As shown, unique identifier 320a is the three character string ‘abc’. Likewise, using fixed data block 310b as input to hashing algorithm 315 results in unique identifier 320b, which is the three character string ‘def’. Finally, using fixed size data block 310c as input to hashing algorithm 315 results in unique identifier 320c, which is the three character string ‘ghi’.

Each of the resulting unique identifiers, can be used to identify the fixed size data block used to create the respective fixed size data block. Thus unique identifier 320a can be used to identify fixed size data block 310a. Likewise, unique identifier 320b can be used to identify fixed size data block 310b, and unique identifier 320c can be used to identify fixed size data block 310c.

Unique identifiers 320a, 320b and 320c, can be transmitted to a content management system to determine if fixed size data blocks 310a, 310b and 310c, are stored on the content management system.

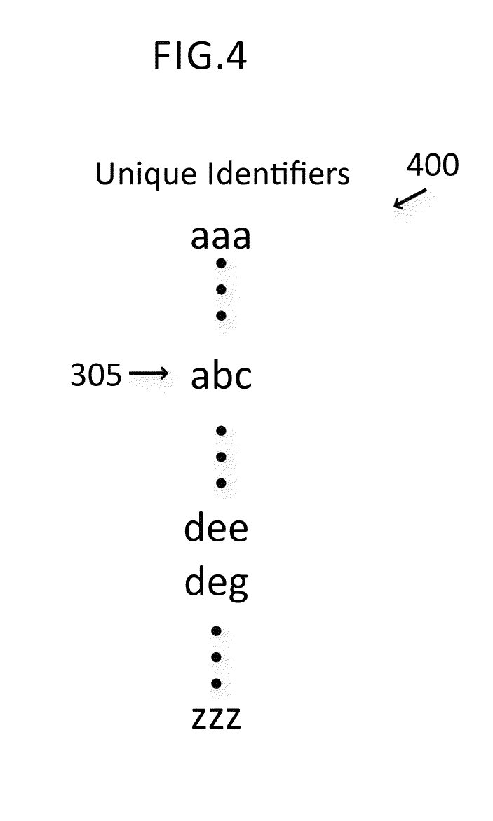

FIG. 4 shows an exemplary embodiment of a content item index 400 used to determine if a fixed size data block is stored on a content management system. As shown, content item index 400 lists unique identifiers. Each unique identifier listed can identify a fixed size data block that is stored on the content management system. Thus, to determine if a fixed size data block is stored on the content management system, content item index 400 can be searched for the unique identifier identifying the fixed size block. If the unique identifier is found in content item index 400, a determination can be made that the fixed size data block is stored on the content management system. Conversely, if the unique identifier is not found in content item index 400, a determination can be made that the fixed size data block is not stored on the content management system.

Using the fixed size data block shown in FIG. 3 as an example, to determine if fixed size data block 310a is stored on the content management system, content item index 400 can be searched for unique identifier 320a, which identifies fixed size data block 310a. Thus, content item index 400 can be searched for the three character string ‘abc’. As shown, content item index 400 includes entry 405 which is the three character string ‘abc’. Thus, it can be determined that fixed size block 310a is stored on the content management system.

To determine if fixed size block 310b is stored on the content management system, content item index 400 can be searched for unique identifier 320b, which is the three character string ‘def’. As shown in FIG. 4, content item index 400 does not include an entry with the three character string ‘def’, and thus it can be determined that fixed size data block 310b is not stored on the content management system.

Returning to the discussion of FIG. 2, in some embodiments, server upload module 136 can be configured to update the content item index. For example, server upload module 136 can be configured to modify the content item index to include the unique identifier of a content item uploaded to content management system 106. In some embodiments, server upload module 136 can be configured to create the unique identifier for a fixed size data block uploaded to content management system 106 and use the created unique identifier to update the content item index. In some embodiments, server upload module 136 can use the unique identifier received from client device 102ᵢ to update the content item index. For example, client upload module 205 can be configured to transmit the unique identifier to content management system 106 when the fixed size data block is uploaded to the content management system. Server upload module 205 can be configured to use the unique identifier received along with the fixed size data block to update the content item index to indicate that the fixed size data block is stored on content management system 106.

In some embodiments, client device 102ᵢ and content management system 106 can be configured to verify that a content item and/or fixed size data block uploaded to content management system 106 matches the content item and/or fixed size data block on client device 102ᵢ. For example, in some instances, a fixed size data block uploaded to content management system 106 may not match the fixed size data block that was intended to be uploaded from client device 102ᵢ. This may be the result of an error during the upload process, or alternatively, due to a modification of the fixed size data block during upload. To ensure that the fixed size data block uploaded to content management system 106 matches the fixed size data block in client device 102i, server upload module 136 can be configured to verify that the uploaded fixed size data block on content management system 106 is the same as the fixed size data block on client device 102ᵢ.

In some embodiments, server upload module 136 can be configured to create a unique identifier for an uploaded fixed size data block and compare the unique identifier with the unique identifier created by client device 102ᵢ for the fixed size data block. For example, client upload module 205 can be configured to transmit the unique identifier created by client upload module 205 to content management system 106 along with the fixed size data block when the fixed size data block is uploaded to content management system 106.

Server upload module 205 can be configured to create a unique identifier for the uploaded fixed size data block using the same method used by client upload module 205 to create the unique identifier for the fixed size data block. For example, in embodiments in which client upload module 205 creates the unique identifier for a fixed size data block by using the fixed size data block as input in a hashing algorithm, server upload module 136 can likewise create the unique identifier by using the uploaded fixed size data block as input to the same hashing algorithm. Thus, if the fixed size data block on client device 102ᵢ and the fixed size data block uploaded to content management system 106 are equal, the unique identifier created by server upload module 136 will be equal to the unique identifier created by client upload module 205.

Server upload module 136 can compare the unique identifier created by server upload module 136 with the unique identifier uploaded by client upload module 205 to determine if the uploaded fixed size data block is equal to the fixed size data block on client device 102ᵢ. If the unique identifier created by server upload module 136 is equal to the unique identifier created by client upload module 205, server upload module 136 can determine that the fixed size data block uploaded to content management system 106 matched the fixed size data block on client device 102ᵢ. Conversely, if the unique identifier created by server upload module 136 does not match the unique identifier uploaded by client upload module 205, server upload module 136 can determine that the fixed size data block uploaded to content management system 106 does not match the fixed size data block on client device 102ᵢ.

Upon determining that a fixed size data block uploaded to content management system 106 does not match the fixed size data block on client device 102ᵢ, server upload module 136 can transmit an error message to client device 102ᵢ notifying client device 102ᵢ that the fixed size data block on content management system 106 does not match the fixed size data block on content management system 102ᵢ. In some embodiments, client upload module 205 can be configured to re-upload the fixed size data block upon receiving the error message from content management system 106. Alternatively, in some embodiments, client upload module 205 can be configured to restart the entire upload process upon receiving the error message.

In some embodiments, content management system 106 can be configured to verify that an entire content item uploaded to content management system 106 matched the content item on client device 102ᵢ. For example, in some embodiments, server upload module 136 can be configured to compare a data size of the content item stored on content management system 106 with the data size of the content item on client device 102ᵢ. Client upload module 205 can be configured to transmit the data size of the entire content item to content management system 106 and server upload module 136 can compare the data size of the content item received from client device 102ᵢ with the data size of the content item stored on content management system 106. Server upload module 136 can determine the data size of the content item by combining the data size of each of the fixed size blocks of the content item stored on content management system 106.

If the data size of the content item received from client device 102ᵢ is not the same as the data size of the content item stored on content management system 106, server upload module 136 can determine that the content item uploaded to content management system 106 does not match the content item on client device 102ᵢ. Alternatively, if the data size of the content item received from client device 102ᵢ is the same as the data size of the content item stored on content management system 106, server upload module 136 can determine that the content item uploaded to content management system 106 matches the content item on client device 102ᵢ. Server upload module 136 can be configured to transmit an error message to client device 102; upon determining that the content item uploaded to content management system 106 does not match the content item on client device 102ᵢ, which can result in the upload process of the content item being restarted.

In some embodiments, content management system 106 can be configured to verify that a content item uploaded to content management system 106 matches the content item on client device 102ᵢ by creating a unique content item identifier for the content item stored on content management system 106 and comparing the unique content item identifier with a unique content item identifier created by client device 102ᵢ. A unique content item identifier can be an identifier that identifies an entire content item, rather than just an individual fixed size block of the content item.

A unique content item identifier can be created in numerous ways known in the art. For example, a unique content item identifier can be created by using at least a portion of the content item as input to a hashing algorithm. The resulting hash output can thus be the unique content item identifier.

Client upload module 205 can be configured to create a unique content item identifier for a content item and transmit the unique content item identifier to content management system 106. Likewise, server upload module 136 can create a unique content item identifier from the content item stored on content management system 106 using the same method used by client upload module 205 to create the unique content item identifier for the content item. For example, server upload module 136 can create the unique content item identifier by using the uploaded content item as input in the same hashing algorithm used by client upload module 102ᵢ to create a unique content item identifier. Thus, the unique content item identifier created by server upload module 136 can be equal to the unique content item identifier created by client upload module 205 when equal input is used by both client upload module 205 and server upload module 136. Server upload module 136 can compare the unique content item identifier created by server upload module 136 to the unique content item identifier created by client upload module 205 to determine if the content item uploaded to content management system 106 matches the content item on client device 102ᵢ.

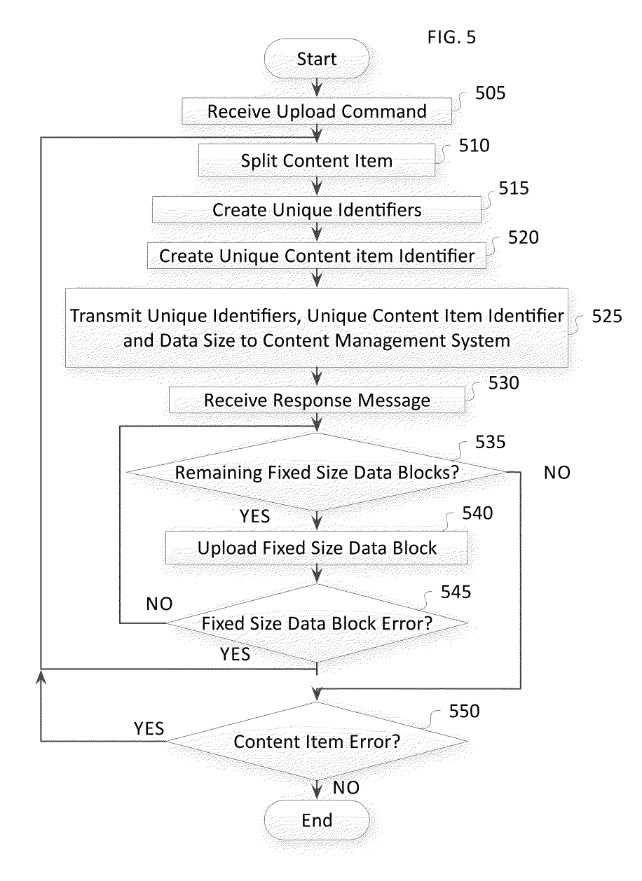

FIG. 5 shows an exemplary method embodiment of a client device uploading a content item to a content management system. Although specific steps are show in FIG. 5, in other embodiments a method can have more or less steps. As shown, the method begins as block 505 where an upload command is received at the client device. An upload command can be a command that identifies a content item to be uploaded to the content management system. For example, an upload command can be transmitted in response to a user selecting to upload a content item to the content management system. Alternatively, an upload command can be transmitted from an automatic upload process running on the client device that identifies content items to be uploaded to the content management system.

Upon receiving the upload command, the method continues to block 510 where the client device splits the content item identified by the upload command into fixed size data blocks. Splitting the content item does not necessarily require creating multiple files from the content item. For example, in some embodiments, the client device can split the content item into fixed size data blocks by scanning the identified content item and identifying each fixed size data block as the content item is scanned.

The method continues to block 515 where the client device creates a unique identifier for each of the fixed size data blocks. A unique identifier can be created by using at least a portion of the fixed size data block as input to a hashing algorithm. The resulting hash output can be the unique identifier for the fixed size data block.

Although steps 510 and 515 are shown separately, in some embodiments the two steps can occur concurrently. For example, in embodiments in which the content item is scanned to identify the fixed size data blocks, the client device can create the unique identifier for each fixed size data block as it is identified while the client device is still scanning any remaining portion of the content item. Thus, the client device can be creating a unique identifier for a fixed size block while also scanning the content item to identify other fixed size data blocks of the content item.

Upon creating a unique identifier for each fixed size data block, the method continues to block 520 where the client device creates a unique content item identifier for the content item. For example, the unique content item identifier can be created by using at least a portion of the content item as input to a hashing algorithm. The resulting hash output can be the unique content item identifier for the content item.

At block 525 the client device transmits the unique identifiers, the unique content item identifier and a data size of the content item to the content management system.

At block 530 a response message is received by the client device from the content management system. The response message can identify any fixed size data blocks of the content item that are not already stored on the content management system and thus need to be uploaded by the client device. For example, the response message can include the unique identifiers for each fixed size data block of the content item that is not stored on the content management system.

The method continues to block 535 where the client device determines if there are any remaining fixed size data blocks of the content item that need to be uploaded to the content management system. For example, the client device can use the response message received from the content management system to determine if there are any fixed size blocks that need to be uploaded. If at block 535 the client device determines that there are fixed size data blocks that need to be uploaded, the method continues to block 540 where the client device uploads one of the fixed size blocks that needs to be uploaded, as well as the unique identifier for the fixed size data block, to the content management system.

The method then continues to block 545 where the client device determines whether a fixed size data block error is received from the content management system. A fixed size block error can indicate that the fixed size data block uploaded to the content management system does not match the fixed size data block on the client device. If a fixed size data block error is received, the method returns to block 510. If a fixed size data block error is not received, the method returns to block 535.

If at block 535, the client device determines that there are no more fixed size data blocks of the content item that need to be uploaded to the content management system, the method continues to block 550 where the method determines if a content item error is received from the content management system. A content item error can indicate that the content item uploaded to the content management system does not match the content item on the client device. If a content item error is received from the content management system, the method return to block 510. If a content item error is not received from the content management system, the content item uploaded to the content management system matches the content item on the client device and the method then ends.

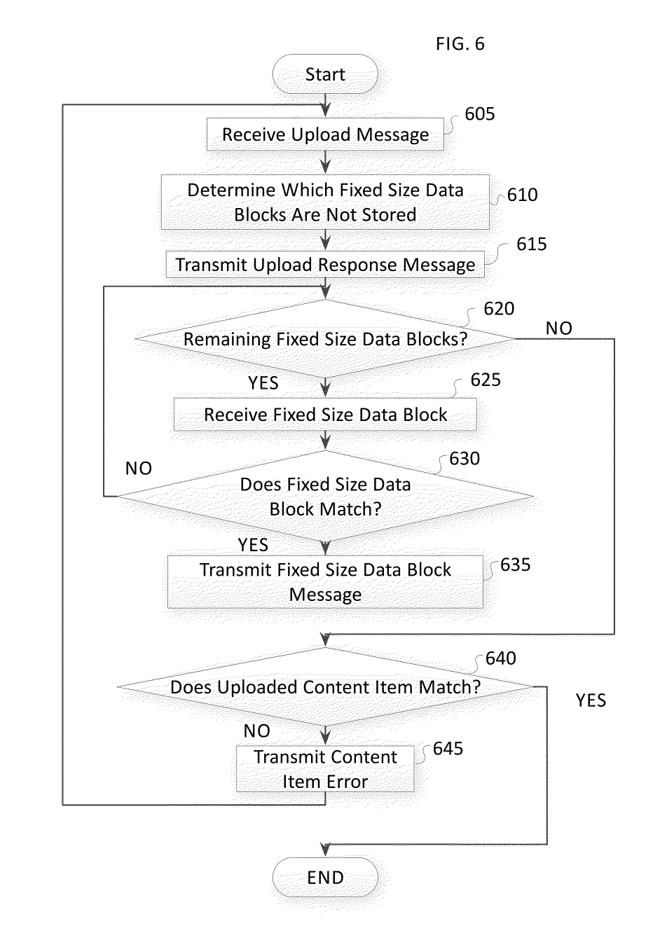

FIG. 6 shows an exemplary method embodiment of a content management system receiving an uploaded content item from a client device. Although specific steps are show in FIG. 5, in other embodiments a method can have more or less steps. As shown, the method begins at block 605 where an upload message is received by the content management system from the client device. The upload message can include a list of unique identifiers that identify each fixed size data block of the content item to be uploaded to the content management system. Further, the upload message can include a data size of the content item and a unique content item identifier that identifies the content item to be uploaded to the content management system.

At block 610, the content management system determines which of the fixed size data blocks are already stored on the content management system. For example, the content management system can search a content item index for each unique identifier listed in the upload message received from the client device. The content item index can be a list of unique identifiers identifying each fixed size data block stored on the content management system. If a unique identifier is found when searching the content item index, the content management system can determine that the fixed size data block identified by the unique identifier is already stored on the content management system. Alternatively, if the unique identifier is not found on the content item index, the content management system can determine that the fixed size data block identified by the unique identifier is not stored on the content management system and thus needs to be uploaded to the content management system by the client device.

At block 615 the content management system transmits an upload response message to the client device that identifies each of the fixed size blocks of the content item that are not stored on the content management system. For example, the upload response message can include the unique identifier for each fixed size data block of the content item that is not stored on the content management system.

At block 620, the content management system determines if there are any remaining content items to be uploaded to the content management system. If at block 620 it is determined that there are fixed size data blocks remaining to be uploaded, the method continues to block 625 where a fixed size data block is received from the client device. The fixed size data block can include the unique identifier for the fixed size data block created by the client device.

At block 630, the content management system can determine if the fixed size data block uploaded to the content management system matches the fixed size data block on the client device. For example, the content management system can create a unique identifier for the uploaded content item using the same method that the client device uses to create a unique identifier. The content management system can compare the unique identifier created by the content management system to the unique identifier created by the client device to determine if the fixed size block uploaded to the content management system matches the content item on the client device. If the unique identifier created by the content management system is equal to the unique identifier received from the client device, the content management system can determine that the fixed size block uploaded to the content management system matches the fixed size data block on the client device and the method can return to block 620.

If, however, the unique identifier created by the content management system is not equal to the unique identifier received from the client device, the content management system can determine that the fixed size block uploaded to the content management system does not match the fixed size block on the client device and the method can continue to block 635 where a fixed size data block error is transmitted to the client device. The method then returns to block 605.

Returning to block 620, if the content management system determines that there are no more fixed size data blocks that need to be uploaded to the content management system from the client device, the method continues to block 640 where the content management system determines if the content item uploaded to the content management system matches the content item on the client device. For example, the content management system can compare the data size of the uploaded content item with the data size received in the upload message from the client device. If the data size of the content item stored on the content management system 106 is equal to the data size received from the client device, the content management system can determine that the content item uploaded to the content management system matches the content item on the client device. If the data size of the content item stored on the content management system does not match the data size received from the client device, the content management system can determine that the content item uploaded to the content management system does not match the content item on the client device.

Alternatively or additionally, the content management system can create a unique content item identifier for the content item stored on the content management system to determine if the content item uploaded to the content management system matches the content item on the client device. For example, the content management system can use the same method to create the unique content item identifier as used by the client device to create a unique content item identifier. The content management system can thus compare the unique content item identifier created by the content management system with the unique content item identifier received in the upload message from the client device. If the unique content item identifier created by the content management system is equal to the unique content item identifier received from the client device, the content management system can determine that the content item uploaded to the content management system matches the content item on the client device. Alternatively, if the unique content item identifier created by the content management system is not equal to the unique content item identifier received from the client device, the content management system can determine that the content item uploaded to the content management system does not match the content item on the client device.

If at block 640 the method determines that the content item uploaded to the content management system matches the content item on the client device, the method ends. Alternatively, if at block 640 the content management system determines that the content item uploaded to the content management system does not matches the content item on the client device, the method continues to block 645 where a content item error is transmitted to the client device. The method then returns to block 605.

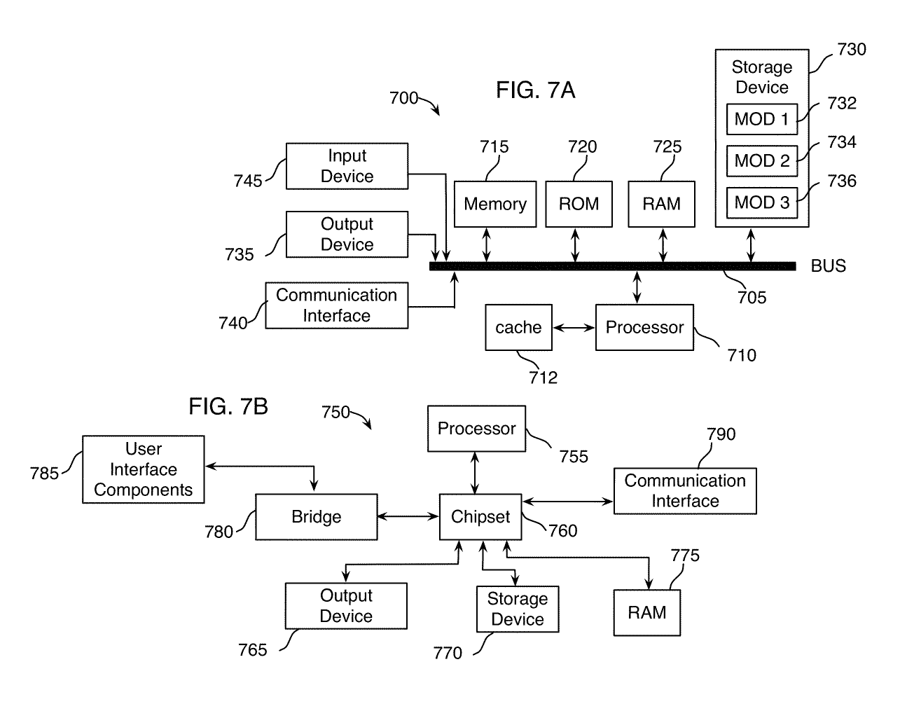

FIG. 7A, and FIG. 7B show exemplary possible system embodiments. The more appropriate embodiment will be apparent to those of ordinary skill in the art when practicing the present technology. Persons of ordinary skill in the art will also readily appreciate that other system embodiments are possible.

FIG. 7A illustrates a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B illustrates a computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that exemplary systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method comprising:
calculating, via a processor, a block identifier based on a received data block of a content item; and
terminating upload of the content item in response to determining that the calculated block identifier differs from a previously received block identifier for the data block.

2. The computer-implemented method of claim 1, wherein the received data block is received from a client device in response to determining that the previously received block identifier is not included in a content item index, the content item index listing block identifiers for data blocks stored on a content management system.

3. The computer-implemented method of claim 1, wherein calculating the block identifier based on the received data block comprises:
applying a hashing algorithm to at least a portion of the received data block, wherein the hashing algorithm is a same hashing algorithm used by a client device to generate the received block identifier.

4. The computer-implemented method of claim 1, wherein terminating upload comprises:
transmitting an error message to a client device.

5. The computer-implemented method of claim 1 further comprising:
in response to determining that all data blocks of the content item are stored on the content management system, comparing a data size for the content item on the content management system with a received data size, and sending a content item upload error when the data size and the received data size differ.

6. A content management system comprising:
a processor; and
a memory containing instructions that, when executed, cause the processor to:
calculate a block identifier based on a received data block of a content item; and
terminate upload of the content item in response to determining that the calculated block identifier differs from a previously received block identifier for the data block.

7. The content management system of claim 6, wherein the received data block is received from a client device in response to determining that the previously received block identifier is not included in a content item index, the content item index listing block identifiers for data blocks stored on the content management system.

8. The content management system of claim 6, wherein calculating the block identifier based on the received data block comprises:
applying a hashing algorithm to at least a portion of the received data block, wherein the hashing algorithm is a same hashing algorithm used by a client device to generate the received block identifier.

9. The content management system of claim 6, wherein terminating upload comprises:
transmitting an error message to a client device.

10. The content management system of claim 6, wherein the instructions further cause the processor to:
in response to determining that all data blocks of the content item are stored on the content management system, compare a data size for the content item on the content management system with a received data size, and sending a content item upload error when the data size and the received data size differ.

11. A computer-implemented method comprising:
calculating, via a processor, a block identifier based on a data block of a content item;
transmitting the data block to a content management system; and
terminating upload the content item in response to receiving an error message from the content management system, the error message sent in response to determining that a calculated block identifier for the data block differs from the block identifier, wherein the calculated block identifier is generated by the content management system.

12. The computer-implemented method of claim 11 further comprising:
prior to completing transmission of the data block, receiving a modification to the data block.

13. The computer-implemented method of claim 11, wherein transmitting the data block occurs in response to receiving a message from the content management system indicating the block identifier is not included in a content item index, the content item index listing block identifiers for data block stored on the content management system.

14. The computer-implemented method of claim 11, wherein calculating the block identifier based on a data block comprises:
applying a hashing algorithm to at least a portion of the data block, wherein the hashing algorithm is a same hashing algorithm used by the content management system to generate the calculated block identifier.

15. The computer-implemented method of claim 11 further comprising:
calculating a new block identifier for the data block; and
re-transmitting the data block to the content management system.

16. A client device comprising:
a processor; and
a memory containing instructions that, when executed, cause the processor to:
calculate a block identifier based on a data block of a content item;
transmit the data block to a content management system; and
terminate upload the content item in response to receiving an error message from the content management system, the error message sent in response to determining that a calculated block identifier for the data block differs from the block identifier, wherein the calculated block identifier is generated by the content management system.

17. The client device of claim 16, the instructions further causing the processor to:
prior to completing transmission of the data block, receive a modification to the data block.

18. The client device of claim 16, wherein transmitting the data block occurs in response to receiving a message from the content management system indicating the block identifier is not included in a content item index, the content item index listing block identifiers for data block stored on the content management system.

19. The client device of claim 16, wherein calculating the block identifier based on a data block comprises:
applying a hashing algorithm to at least a portion of the data block, wherein the hashing algorithm is a same hashing algorithm used by the content management system to generate the calculated block identifier.

20. The client device of claim 16, the instructions further causing the processor to:
calculate a new block identifier for the data block; and
re-transmit the data block to the content management system.
